(19) United States
(12) Patent Application Publication
(10) Pub. No.: US 2017/0372314 A1
(43) Pub. Date: Dec. 28, 2017

(54) PROCESSING OF DISPUTE ALERTS

(71) Applicant: Midigator LLC, St. Thomas, VI (US)

(72) Inventors: Corey Baggett, St. Thomas, VI (US); Eric Nordyke, St. Thomas, VI (US); Benjamin Hale, St. Thomas, VI (US)

(21) Appl. No.: 15/191,331

(22) Filed: Jun. 23, 2016

(51) Int. Cl. G06Q 20/40; G06Q 20/38; G06F 17/30

(52) U.S. Cl. CPC G06Q 20/407; G06F 17/30424; G06Q 20/389

(57) ABSTRACT

The subject matter disclosed herein provides methods for processing a dispute alert. The method may include receiving a dispute alert that includes a first plurality of transaction descriptors associated with a disputed transaction; executing a first web service request to retrieve a first recorded transaction from a customer relationship management system, wherein the first recorded transaction is associated with a second plurality of transaction descriptors; determining whether the disputed transaction matches the first recorded transaction at least by generating a weighted sum of at least one transaction descriptor from the first plurality of transaction descriptors that matches a transaction descriptor from the second plurality of transaction descriptors; and when the disputed transaction is determined to match the first recorded transaction, executing a second web service request to cause the customer relationship management system to issue a refund for the disputed transaction. Related apparatus, systems, techniques, and articles are also described.

### TECHNICAL FIELD

This disclosure relates generally to the processing of alerts.

### BACKGROUND

A chargeback occurs when a payment cardholder disputes a transaction with a merchant processor or a card issuing bank. For example, the cardholder may not recognize a transaction that arose through error (e.g., the processor's and/or issuer's technical or clerical mishap) or fraud (e.g., identity theft by a malicious third party). The cardholder may also dispute a transaction for quality reasons (e.g., non-delivery, inferior goods or services). But regardless of the reason, a disputed transaction can trigger a chargeback process that is particularly onerous for a merchant. For instance, the typical chargeback process allows the merchant's bank to investigate and determine the legitimacy of the disputed transaction before the merchant is afforded an opportunity to refute the chargeback. Moreover, the merchant processor or issuing bank can charge the merchant with a processing fee for each chargeback and levy additional fines when the merchant incurs a large number of chargebacks. In extreme cases, a large number of chargebacks can even cause the merchant of payment card (e.g., credit and/or debit) processing privileges altogether.

### SUMMARY

Methods, systems, and articles of manufacture, including computer program products, are provided for processing one or more dispute alerts. In some example embodiments, there is provided a method that includes: receiving, from a dispute alert provider, a dispute alert indicating a disputed transaction, wherein the dispute alert includes a first plurality of transaction descriptors characterizing the disputed transaction; executing, in response to the received dispute alert, a first web service request to retrieve a first recorded transaction from a customer relationship management system, wherein the first recorded transaction is characterized by a second plurality of transaction descriptors; determining whether the disputed transaction matches the first recorded transaction at least by generating a weighted sum of at least one transaction descriptor from the first plurality of transaction descriptors that matches a transaction descriptor from the second plurality of transaction descriptors; and executing, when the disputed transaction matches the first recorded transaction, a second web service request to cause the customer relationship management system to issue a refund for the disputed transaction.

In some variations, the first plurality of transaction descriptors may indicate at least one of a date and time when the disputed transaction was executed, a merchant that processed the disputed transaction, an amount of the disputed transaction, a status of the disputed transaction, a currency of the disputed transaction, and a reason for the disputed transaction. The method may further include receiving, in response to executing the first web service, the first recorded transaction provided by the customer relationship management system. The first web service may be executed by least calling a Hypertext Transfer Protocol GET request. The determining may further include: generating the weighted sum to include a weight assigned to the at least one transaction descriptor from the first plurality of transaction descriptors that matches a transaction descriptor from the second plurality of transaction descriptors; and determining whether the weighted sum exceeds a threshold. The second web service may be executed by at least calling a Hypertext Transfer Protocol PUT request.

In some variations, the method may further include: receiving, from a merchant associated with the customer relationship management system, one or more recorded transactions; storing, in a relational database, one or more recorded transactions received from the merchant; and retrieving, from the relational database, a second recorded transaction, wherein the retrieving includes executing one or more Structured Query Language operations; and determining whether the disputed transaction matches the second recorded transaction retrieved from the relational database.

In some variations, the method may further include: executing, when the disputed transaction is determined to match the first recorded transaction, a third web service request to determine whether the disputed transaction has already been refunded and/or canceled by the customer relationship management system; and executing, when the disputed transaction is determined to match the first recorded transaction, the second web service request to cause the customer relationship management system to issue the refund when the disputed transaction has not already been refunded and/or canceled by the customer relationship management system. The third web service request may be executed by at least calling a Hypertext Transfer Protocol GET request.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF DRAWINGS

The accompanying drawings, which are incorporated herein and constitute a part of this specification, show certain aspects of the subject matter disclosed herein and, together with the description, help explain some of the principles associated with the subject matter disclosed herein. In the drawings,

FIG. 1 depicts a block diagram illustrating a network environment for processing dispute alerts, in accordance with some example embodiments;

FIG. 2 depicts a block diagram illustrating a dispute alert processor, in accordance with some example embodiments;

FIG. 3 depicts a flowchart illustrating a process for processing one or more dispute alerts, in accordance with some example embodiments;

FIG. 4 depicts a graphic user interface, in accordance with some example embodiments; and

FIG. 5 depicts a flowchart illustrating a process for processing one or more dispute alerts, in accordance with some example embodiments.

Like reference symbols in the various drawings indicate like elements.

### DETAILED DESCRIPTION

A dispute alert may be triggered when a cardholder disputes a transaction. For example, in response to a disputed transaction by a cardholder, a card issuing bank and/or a third party dispute alert provider may notify the merchant affected by the disputed transaction. As such, the merchant may be given an opportunity to resolve the disputed transaction (e.g., by providing a refund to the cardholder) without triggering the conventional chargeback process noted above. However, it may still be incumbent upon the merchant to investigate the legitimacy of the disputed transaction.

In some example embodiments, a dispute alert processor can respond to dispute alerts from the card issuing bank and/or the dispute alert provider. For instance, the dispute alert processor can respond to a dispute alert by verifying the disputed transaction. According to some example embodiments, the dispute alert processor may store at least a portion of a merchant's recorded transactions (e.g., orders). Thus, to verify a disputed transaction, the dispute alert processor may attempt to locate a matching transaction amongst the recorded transactions stored at dispute alert processor. In addition, the dispute alert processor further verifies the disputed transaction by attempting to locate a matching transaction amongst the recorded transactions stored by the merchant's customer relationship management system.

In some example embodiments, the disputed and the recorded transaction may both be associated with a plurality of transaction descriptors (e.g., transaction date, amount, type). As such, the dispute alert processor may identify matching transaction descriptors between the disputed transaction and the recorded transaction. Moreover, different transaction descriptors may be assigned different weights to reflect, for example, the importance and/or priority of matching each transaction descriptor. For instance, more specific transaction descriptors such as the credit card information associated with a transaction may be assigned a higher weight than more common transaction descriptors such as the date and amount of a transaction. The dispute alert processor may determine a weighted sum of the matching transaction descriptors between a disputed transaction and a recorded transaction. The dispute alert processor can determine that a disputed transaction matches a recorded transaction when the weighted sum exceeds a threshold.

In some example embodiments, when the dispute alert processor is able to verify a disputed transaction (e.g., by locating a matching transaction at the dispute alert processor and at a merchant's customer relationship management system), the dispute alert processor may be configured to resolve the disputed transaction by at least providing a refund (e.g., to a cardholder). For instance, the dispute alert processor may cause the merchant's customer relationship management system to issue the refund. As such, the dispute alert processor may resolve the disputed transaction without triggering the conventional chargeback process. Moreover, the dispute alert processor may resolve the disputed transaction automatically and in a manner that is transparent to the affected merchant.

In some example embodiments, the dispute alert processor may be configured to provide, via a graphic user interface, data associated with at least a portion of a merchant's dispute alerts. For example, the dispute alert processor may provide, via the graphic user interface, data related to individual disputed transactions and/or groups of disputed transactions (e.g., from a specified time period). The dispute alert processor may further provide, via the graphic user interface, data for disputed transactions that have been sorted based on one or more transaction descriptors associated with the disputed transactions including, for example, an originating dispute alert provider, country, bank, price point, and/or product.

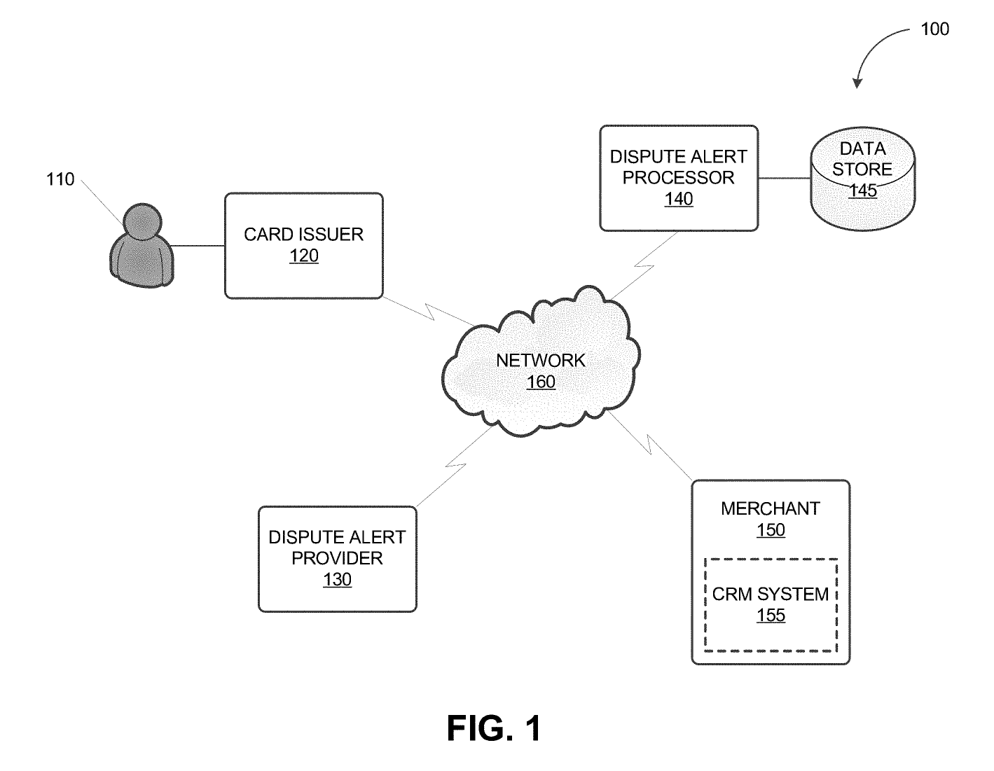

FIG. 1 depicts a block diagram illustrating a network environment 100 for processing dispute alerts, in accordance with some example embodiments. Referring to FIG. 1, a card issuer 120, a dispute alert provider 130, a dispute alert processor 140, and a merchant 150 may be communicatively coupled via a wired and/or wireless network 160. The network 160 may include, for example, a wide area network, a local area network, and/or the Internet.

As shown in FIG. 1, a user 110 may dispute a transaction with the card issuer 120. For example, the user 110 may dispute the transaction by contacting the card issuer 120 (e.g., by Internet, mail, facsimile, electronic mail, in person, short messaging service text, telephone).

In some example embodiments, the card issuer 120 may notify (e.g., via the network 160) the dispute alert provider 130 of the disputed transaction. The dispute notification from the card issuer 120 may include data describing the disputed transaction including, for example, merchant, timestamp, amount, payment card number, and type of transaction. According to some example embodiments, the card issuer 120 may notify the dispute alert provider 130 of the disputed transaction instead of initiating a conventional chargeback process.

In some example embodiments, in response to the dispute notification from the card issuer 120, the dispute alert provider 130 may transmit a dispute alert to the dispute alert processor 140. The dispute alert may be transmitted to the dispute alert processor 140 instead of the merchant 150 for further handling. According to some example embodiments, the dispute alert provider 130 may push the dispute alert to the dispute alert processor 140 using one or more web service requests (e.g., Hypertext Transfer Protocol POST requests). The dispute alert may be further provided via an encrypted link (e.g., Secure Socket Layer).

In some example embodiments, the dispute alert processor 140 may receive a dispute alert (e.g., from the dispute alert provider 130) and transform the data included in the dispute alert for further handling and storage by the dispute alert processor 140. The dispute alert may include a plurality of transaction descriptors that characterize a disputed transaction. As such, the dispute alert processor 140 may execute one or more scripts (e.g., in PHP: Hypertext Preprocessor) to standardize and scrub the data to, for example, change and remove incorrect, incomplete, improperly formatted, and/or duplicate transaction descriptors.

In some example embodiments, the dispute alert processor 140 may verify the disputed transaction based at least in part on the transaction descriptors included in the dispute alert. For example, the dispute alert processor 140 may attempt to match the disputed transaction with at least one of the recorded transactions associated with the merchant 150. The dispute alert processor 140 may attempt to locate at least one matching transactions amongst the recorded transactions stored by the dispute alert processor 140 (e.g., at a data store 145). According to some example embodiments, the dispute alert processor 140 can include an open application programing interface server (not shown) that is configured to receive recorded transactions pushed from a merchant (e.g., the customer relationship management system 155). Alternately or additionally, the dispute alert processor 140 can perform (e.g., automatically) data pull operations to obtain recorded transactions from the merchant. These data pull operations can access the merchant's third party application programming interface.

According to some example embodiments, when the dispute alert processor 140 is unable to locate a matching recorded transaction, the dispute alert processor 140 may automatically perform one or more corrective operations (e.g., updates) and reprocess the disputed transaction (e.g., by again attempting to locate a matching recorded transaction). This automated process may be performed periodically (e.g., every 15 minutes) and/or upon completion of the corrective operations. By contrast, if the dispute alert processor 140 is able to locate a matching recorded transaction, the dispute alert processor 140 may further verify the disputed transaction with the customer relationship management system 155 of the merchant 150. For instance, the dispute alert processor 140 may verify the disputed transaction by attempting to locate a matching recorded transaction at the customer relationship management system 155.

In some example embodiments, to determine a match between the disputed transaction and one or more recorded transactions, the dispute alert processor 140 may compare transaction descriptors characterizing the disputed transaction and transaction descriptors characterizing one or more recorded transactions. Each transaction descriptor may be associated with a weight that reflects, for example, an importance and/or priority of matching that particular transaction descriptor. Accordingly, the dispute alert processor 140 may determine a weighted sum of the matching transaction descriptors between the disputed transaction and a recorded transaction. A disputed transaction may be determined to match a recorded transaction when the weighted sum of the matching transaction descriptors exceeds a threshold.

In some example embodiments, if the dispute alert processor 140 is able to verify the disputed transaction (e.g., by locating a recorded transaction that matches the disputed transaction at the dispute alert processor 140 and the customer relationship management system 155), the dispute alert processor 140 may provide a refund to the user 110. For example, the dispute alert processor 140 may provide the refund by causing the customer relationship management system 155 to issue a refund to the user 110.

In some example embodiments, the dispute alert processor 140 may store a status of a plurality of disputed transaction (e.g., in the data store 145). As such, the dispute alert processor 140 may update the stored status of a disputed transaction when the dispute alert processor 140 is able to verify the disputed transaction and provide a refund (e.g., to the user 110). The dispute alert processor 140 may also update the stored status of a disputed transaction when the dispute alert processor 140 is unable to resolve a disputed transaction (e.g., failed verification and/or refund). For example, the dispute alert processor 140 may update the status of the disputed transaction to indicate whether the disputed transaction has been resolved. Alternately or additionally, the dispute alert processor 140 may provide an update of the status of a disputed transaction to the dispute alert provider 130, the card issuer 120, and/or the merchant 150.

Although FIG. 1 depicts a single card issuer (e.g., the card issuer 120), dispute alert provider (e.g., the dispute alert provider 130), and merchant (e.g., the merchant 150), the network environment 100 can include additional card issuers, alert providers, and/or merchants communicatively coupled with the dispute alert processor 140 without departing from the scope of the present disclosure.

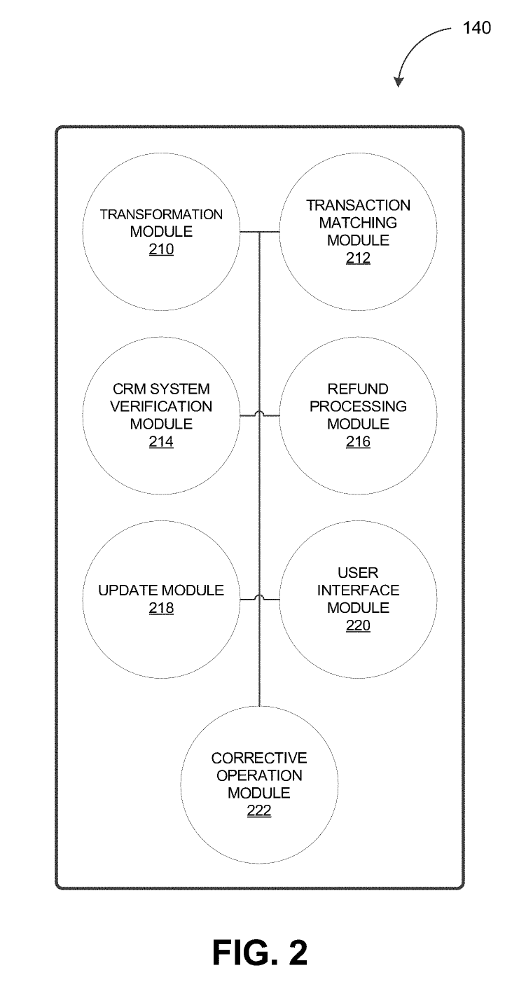

FIG. 2 depicts a block diagram illustrating the dispute alert processor 140, in accordance with some example embodiments. The dispute alert processor 140 may include at least one processor, such as a computer, a server, a tablet, smartphone, and/or the like, and at least one memory including program code to provide one or more functions, such as modules. In some example embodiments, the dispute alert processor 140 including the modules may be implemented on separate processors coupled by a link, a bus, a network, and/or the like. In some example embodiments, the dispute alert processor 140 including the modules may be implemented at a cloud based server.

Referring to FIGS. 1-2, the dispute alert processor 140 may include a transformation module 210, transaction matching module 212, a customer relationship management system verification module 214, a refund processing module 216, an update module 218, a user interface module 220, and a corrective operation module 222.

In some example embodiments, the transformation module 210 may be configured to receive a dispute alert (e.g., from the dispute alert provider 130 and/or the card issuer 120) for a disputed transaction and transform the data included in the dispute alert into a standardized format for further processing and/or storage. The dispute alert may include a plurality of transaction descriptors characterizing various aspects of the disputed transaction including, for example, issuer name (e.g., of the card issuer 120), source, fraud type, alert date and time, match timestamp, merchant descriptor (e.g., name and/or identifier), card number, transaction date and time, amount, currency, transaction type, outcome, stop status, refund status, date and time flagged as fraud, alert age (e.g., hours), chargeback initiator (e.g., the user 110), merchant category classification, date and time of outcome update, outcome updated by, comments, acquirer reference number, alert type, chargeback amount, chargeback currency, chargeback reason code, and transaction identifier. The transformation module 210 may perform transformations that includes, for example, standardizing and scrubbing (e.g., change and remove incorrect, incomplete, improperly formatted, and/or duplicate transaction descriptors) the data included in the dispute alert into a standardized format for further processing and/or storage. According to some example embodiments, data included in the dispute alert may be transformed prior to additional handling and/or storage by the dispute alert processor 140.

The transaction matching module 212 may attempt to locate one or more recorded transactions stored by the dispute alert processor 140 (e.g., in the data store 145) that match the disputed transaction. For example, the transaction matching module 212 may compare transaction descriptors characterizing the disputed transaction against transaction descriptors characterizing each of a plurality of recorded transactions. According to some example embodiments, to determine whether a disputed transaction matches a recorded transaction, the transaction matching module 212 may generate a weighted sum S of an n number matching transaction descriptors (e.g., d₁, d₂, . . . dₙ) between the disputed transaction and the recorded transaction. The weighted sum S may be determined as follows:

S=Σᵢ₌₁ⁿwᵢdᵢ=w₁d₁+w₂d₂+ . . . +wₙdₙ,

wherein wᵢ may be the weight associated with a corresponding transaction descriptor dᵢ.

For instance, a disputed transaction and a recorded transaction may have a plurality of matching transaction descriptors including, for example, a same merchant, card number, transaction date and time, and currency. Each transaction descriptor may be assigned a weight that reflects, for example, an importance and/or priority of matching that particular transaction descriptor. Thus, the weighted sum of the matching transaction descriptors may be a sum of the respective weights assigned to, for example, the merchant transaction descriptor, the card number transaction descriptor, the transaction date and time transaction descriptor, and the currency transaction descriptor. The transaction matching module 212 may determine that the disputed transaction match the recorded transaction when the weighted sum of matching transaction descriptors exceeds a threshold.

In some example embodiments, the customer relationship management system verification module 214 may attempt to locate one or more recorded transactions that match a disputed transaction. For example, the customer relationship management system verification module 214 may determine one or more weighted sums of matching transaction descriptors between the disputed transaction and a recorded transaction. The customer relationship management system verification module 214 may attempt to locate matching recorded transactions amongst the recorded transactions stored by one or more customer relationship management systems (e.g., the customer relationship management system 155 of the merchant 150). For instance, the customer relationship management system verification module 214 may interact with the customer relationship management system 155 at least by executing one or more scripts (e.g., in PHP: Hypertext Preprocessor) that calls a plurality of web service requests (e.g., Hypertext Transfer Protocol GET, POST, and/or PUT requests) to retrieve recorded transactions from the customer relationship management system 155. The customer relationship management system verification module 214 may determine whether the information for the disputed transaction (e.g., transaction descriptors) retrieved from the customer relationship management system 155 matches the information for the disputed transaction stored at the dispute alert processor 140.

According to some example embodiments, the customer relationship management system verification module 214 may provide additional verification for a disputed transaction that is already matched to a recorded transaction by the transaction matching module 212. For example, the customer relationship management module 214 may attempt to locate matching recorded transactions at a customer relationship management system (e.g., the customer relationship management system 155) after the transaction matching module 212 locates a matching recorded transaction amongst the recorded transactions stored at by the dispute alert processor 140 (e.g., at the data store 145).

In some example embodiments, the refund processing module 216 may be configured to provide a refund (e.g., to the user 110) when the dispute alert processor 140 (e.g., the transaction matching module 212 and/or the customer relationship management system verification module 214) is able to verify a disputed transaction. For example, the refund processing module 216 may execute one or more scripts (e.g., in PHP: Hypertext Preprocessor) that calls a plurality of web service requests (e.g., Hypertext Transfer Protocol GET, POST, and/or PUT requests) to cause a customer relationship management system (e.g., the customer relationship management system 155 of the merchant 150) to issue a refund (e.g., to the user 110).

In some example embodiments, the update module 218 may be configured to update a status of a disputed transaction to indicate whether the disputed transaction was successfully resolved (e.g., verified, refunded). The update module 218 may be configured to update the status of the disputed transaction stored at the dispute alert processor 140 (e.g., at the data store 145). For example, the data store 145 may be a Structured Query Language (SQL) based relational database. As such, the update module 218 may execute one or more scripts (e.g., in PHP: Hypertext Preprocessor) that calls one or more Structure Query Language operations (e.g., insert, update, delete) to update the status of the disputed transaction stored in the data store 145. In addition, the update module 218 may also provide an update of the status of a disputed transaction to a corresponding card issuer (e.g., the card issuer 120), dispute alert provider (e.g., the dispute alert provider 130), and/or merchant (e.g., the merchant 150). For instance, the update module 218 may execute one or more web service requests (e.g., Hypertext Transfer Protocol POST) to provide the status updates. Moreover, the update module 218 may provide the updates via an encrypted link (e.g., Secure Socket Layer).

The user interface module 220 may be configured to provide, to an affected merchant (e.g., the merchant 150), data corresponding to a specific disputed transaction and/or groups of disputed transactions. In some example embodiments, the user interface module 220 may provide, via a graphic user interface, data for disputed transactions that have been sorted based on one or more transaction descriptors associated with the transactions (e.g., an originating dispute alert provider, country, bank, price point, and/or product).

In some example embodiments, the corrective operation module 222 may be configured to perform one or more corrective operations in response to a failure by the transaction matching module 212 to match a disputed transaction with at least one recorded transaction stored at the dispute alert processor 140. The corrective operation module 222 may also perform one or more corrective operations when the customer relationship management system module 214 is unable to match the disputed transaction with one or more recorded transactions stored by a customer relationship management system (e.g., the customer relationship management system 155). In addition, the corrective operation module 222 may perform one or more corrective operations in response to external failures including, for example, a failure by a customer relationship management system (e.g., the customer relationship management system 155) to issue a refund.

In some example embodiments, a disputed transaction may fail to match at least one recorded transaction when a merchant descriptor (or permutations thereof) associated with the disputed transaction fails to match the merchant descriptor of any recorded transactions. As such, the corrective operation module 222 can be configured to update its library of merchant descriptors while the disputed transaction may be reprocessed (e.g., automatically) with the new merchant descriptors. Alternately or additionally, the corrective operation module 222 can respond external failures by updating application programming interface access credentials (e.g., to the customer relationship management system 155) and internet protocol white lists.

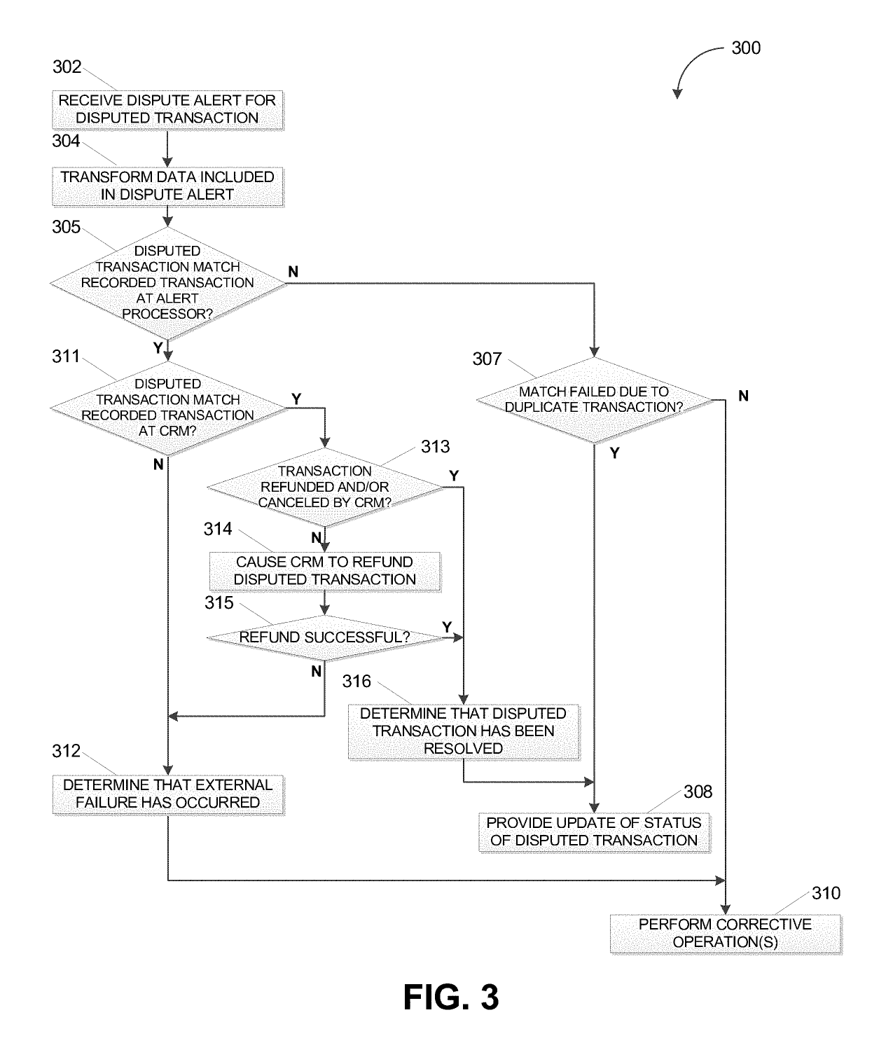

FIG. 3 depicts a flowchart illustrating a process 300 for processing one or more dispute alerts. Referring to FIGS. 1-3, the process 300 may be performed by the dispute alert processor 140.

The dispute alert processor 140 may receive, from a dispute alert provider, a dispute alert for a disputed transaction (302). For example, the dispute alert processor 140 may receive a dispute alert pushed (e.g., using one or more web service requests) from the dispute alert provider 130 and/or the card issuer 120. The dispute alert may include a plurality of transaction descriptors characterizing various aspects of the disputed transaction including, for example, transaction descriptors that indicate when and where the disputed transaction was executed, the current status of the disputed transaction, and an amount of the disputed transaction. Specifically, the plurality of transaction descriptor may include, for example, an issuer name (e.g., of the card issuer 120), source, fraud type, alert date and time, match timestamp, merchant descriptor (e.g., name and/or identifier), card number, transaction date and time, amount, currency, transaction type, outcome, stop status, refund status, date and time flagged as fraud, alert age (e.g., hours), chargeback initiator (e.g., the user 110), merchant category classification, date and time of outcome update, outcome updated by, comments, acquirer reference number, alert type, chargeback amount, chargeback currency, chargeback reason code, and transaction identifier.

The dispute alert processor 140 may transform the data included in the dispute alert (304). For example, the dispute alert processor 140 may transform the data included in the dispute alert to change and remove incorrect, incomplete, improperly formatted, and/or duplicate transaction descriptors.

The dispute alert processor 140 may determine whether the disputed transaction matches at least one recorded transaction stored by the dispute alert processor 140 (305). In some example embodiments, the dispute alert processor 140 may store, in a Structured Query Language based relational database (e.g., the data store 145), at least a portion of the recorded transactions from the merchant 150. As such, the dispute alert processor 140 may execute one or more Structured Query Language operations to locate and retrieve recorded transactions stored by the dispute alert processor 140 in the Structured Query Language based relational database (e.g., the data store 145).

In some example embodiments, the dispute alert processor 140 may generate a weighted sum of matching transaction descriptors between the disputed transaction and the recorded transactions. For example, the disputed transaction and a recorded transaction may share a plurality of matching transaction descriptors including, for example, a same merchant descriptor, card number, transaction date and time, and currency. The dispute alert processor 140 may generate a weighted sum of the matching transaction descriptors. The disputed transaction may be determined to match a recorded transaction when the weighted sum of the matching transaction descriptors between the two transactions exceeds a threshold.

If the dispute alert processor 140 determines that the disputed transaction does not match any of the recorded transactions stored at the dispute alert processor 140 (305-N), the dispute alert processor 140 may determine whether a match failed because the disputed transaction is a duplicate transaction (307). For example, the dispute alert processor 140 may be unable to locate a match for the disputed transaction when all recorded transactions matching the disputed transaction are flagged with a duplicate alert.

In some example embodiments, the dispute alert processor 140 may flag a recorded transaction with a duplicate alert the first time the dispute alert processor 140 matches the recorded transaction to a disputed transaction. As such, in the event the dispute alert processor 140 subsequently receives another dispute alert for the same disputed transaction, the dispute alert processor 140 may be able to determine, based on the duplicate alert, that the disputed transaction has already been processed. Thus, if the dispute alert processor 140 determines that the match failed because the disputed transaction is a duplicate transaction (307-Y), the dispute alert processor 140 may provide a corresponding update of the status of the disputed transaction (308). For example, the dispute alert processor 140 may update (e.g., by executing one or more Structured Query Language operations) a status of the disputed transaction stored at the dispute alert processor 140 (e.g., the data store 145) to indicate that the disputed transaction is a duplicate transaction. The dispute alert processor 140 may further provide an update of the status of the disputed transaction to the card issuer 120, the dispute alert provider 130, and/or the merchant 150 (e.g., via one or more web service requests).

Alternately or additionally, if the dispute alert processor 140 determines that the match did not fail because the disputed transaction is a duplicate (307-N), the dispute alert processor 140 may perform one or more corrective operations (310). For example, the dispute alert processor 140 may perform updates to resolve inconsistencies (e.g., formatting) in the transaction descriptors associated with disputed and/or recorded transactions. In some example embodiments, the one or more corrective operations may be adapted to improve a likelihood that the disputed transaction may be successfully matched to a recorded transaction (e.g., during an automatic reprocessing of the disputed transaction).

If the dispute alert processor 140 determines that the disputed transaction matches at least one recorded transaction stored at the dispute alert processor 140 (305-Y), the dispute alert processor 140 may determine whether the disputed transaction matches at least one recorded transaction stored by a corresponding merchant's customer relationship management system (311). The dispute alert processor 140 may perform an additional verification of the disputed transaction after the disputed transaction is matched to at least one recorded transaction stored at the dispute alert processor 140. For example, the dispute alert processor 140 may execute one or more scripts (e.g., in PHP: Hypertext Preprocessor) that calls a plurality of web service requests (e.g., Hypertext Transfer Protocol GET, POST, and/or PUT requests) to retrieve recorded transactions from the customer relationship management system 155 of the merchant 150. To determine whether the disputed transaction matches at least one recorded transaction stored by the customer relationship management system 155, the dispute alert processor 140 may generate weighted sums of matching transaction descriptors between the disputed transaction and one or more recorded transactions from the customer relationship management system 155.

If the dispute alert processor 140 determines that the disputed transaction does not match at least one recorded transaction stored by the corresponding merchant's customer relationship management system (311-N), the dispute alert processor 140 may determine that an external failure has occurred (312). For instance, the dispute alert processor 140 may determine that a failure has occurred at the customer relationship management system 155 of the merchant 150. Moreover, in response to determining that an external failure has occurred, the dispute alert processor 140 may perform one or more corrective operations (310). For example, the dispute alert processor 140 may perform updates to resolve inconsistencies (e.g., formatting) in the transaction descriptors associated with disputed and/or recorded transactions.

Alternately or additionally, if the dispute alert processor 140 determines that the disputed transaction does match at least one recorded transaction stored by the corresponding merchant's customer relationship management system (311-Y), the dispute alert processor 140 may determine whether the disputed transaction has already been refunded and/or cancelled by the customer relationship management system (313). For example, the dispute alert processor 140 may execute one or more web service requests (e.g., Hypertext Transfer Protocol GET, POST, and/or PUT requests) to retrieve data from the customer relationship management system 155 indicating whether the disputed transaction has already been refunded and/or canceled.

If the dispute alert processor 140 determines that the disputed transaction has not already been refunded and/or canceled by the customer relationship management system (313-N), the dispute alert processor 140 may cause the merchant's customer relationship management system to refund the disputed transaction (314). For example, if data retrieved from the customer relationship management system 155 indicates that the disputed transaction has not been refunded and/or canceled, the dispute alert processor 140 may execute one or more web service requests (e.g., Hypertext Transfer Protocol GET, POST, and/or PUT requests) that causes the customer relationship management system 155 to issue a refund (e.g., to the user 110).

The dispute alert processor 140 may further determine whether the refund was successfully issued by the merchant's customer relationship management system (315). For example, the dispute alert processor 140 may determine whether the refund was successfully issued by the customer relationship management system 155 based on a refund status provided by the customer relationship management system 155 (e.g., pushed or pulled via one or more web service requests). If the dispute alert processor 140 determines that the refund was successfully issued (315-Y), the dispute alert processor 140 may determine that the disputed transaction has been resolved (316). The dispute alert processor 140 may further provide a corresponding update of the status of the disputed transaction (308). For example, the dispute alert processor 140 update (e.g., by executing one or more Structured Query Language operations) a status of the disputed transaction stored at the dispute alert processor 140 (e.g., the data store 145) to indicate that the disputed transaction has been resolved (e.g., refunded). The dispute alert processor 140 may further provide an update of the status of the disputed transaction to the card issuer 120, the dispute alert provider 130, and/or the merchant 150 (e.g., via one or more web service requests).

Alternately or additionally, if the dispute alert processor determines that the refund was not successfully issued (315-N), the dispute alert processor 140 may determine that an external failure has occurred (312). For instance, the dispute alert processor 140 may determine that a failure has occurred at an external entity such as the customer relationship management system 155 of the merchant 150. Moreover, in response to determining that an external failure has occurred, the dispute alert processor 140 may perform one or more corrective operations (310). For example, the dispute alert processor 140 may perform updates to resolve inconsistencies (e.g., formatting) in the transaction descriptors associated with disputed and/or recorded transactions.

Alternately or additionally, if the dispute alert processor 140 determines that the disputed transaction has already been refunded and/or canceled by the customer relationship management system (313-Y), the dispute alert processor 140 may determine that the disputed transaction has been resolved (316). The dispute alert processor 140 may further provide a corresponding update of the status of the disputed transaction (308). For example, the dispute alert processor 140 update (e.g., by executing one or more Structured Query Language operations) a status of the disputed transaction stored at the dispute alert processor 140 (e.g., the data store 145) to indicate that the disputed transaction has been resolved (e.g., refunded). The dispute alert processor 140 may further provide an update of the status of the disputed transaction to the card issuer 120, the dispute alert provider 130, and/or the merchant 150 (e.g., via one or more web service requests).

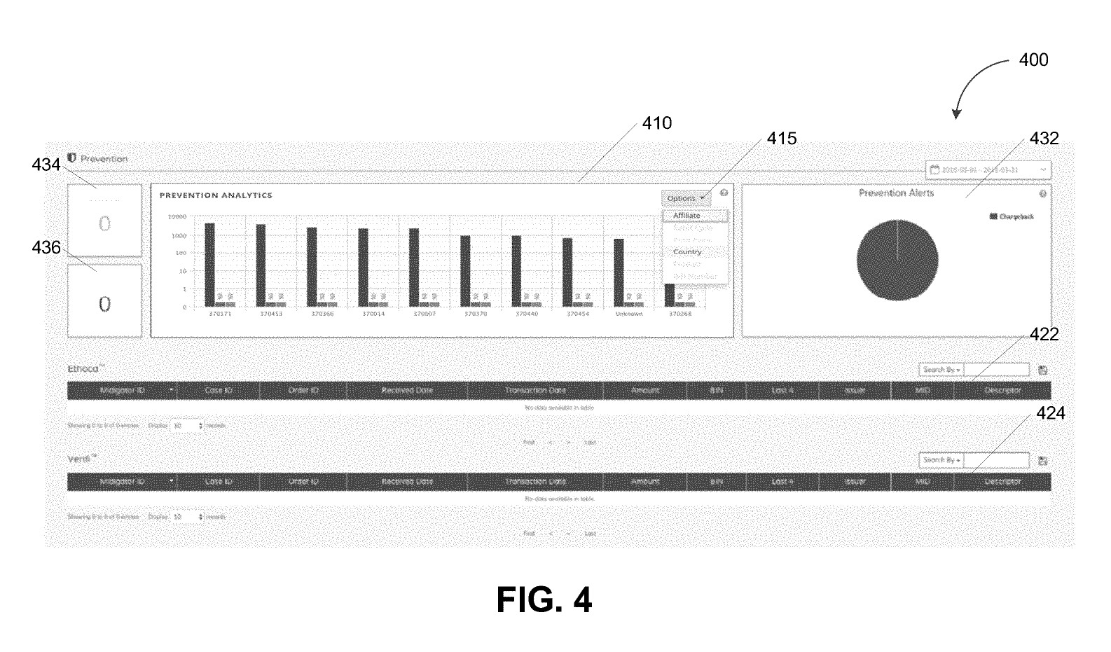

FIG. 4 depicts a graphic user interface 400, in accordance with some example embodiments. Referring to FIGS. 1-4, the graphic user interface 400 may be provided by the dispute alert processor 140 (e.g., the user interface module 220) at, for example, operation 308 of the process 300.

As shown in FIG. 4, the graphic user interface 400 may include a prevention analytics panel 410. The prevention analytics panel 410 may display the disputed transactions corresponding to a merchant's (e.g., the merchant 150) dispute alerts. The disputed transactions may be sorted based on one or more user selectable (e.g., via a dropdown menu 415) transaction descriptors including, for example, price point, country, product, and bank identification number. The one or more user selectable transaction descriptors may further include one or more specific affiliates, which may be third party entities (e.g., high traffic news websites) contracted by a merchant to boost sales by through endorsements and other advertisements.

In some example embodiments, the graphic user interface 400 may further include separate panels for different dispute alert providers. For example, as shown in FIG. 4, the graphic user interface 400 may include a first dispute alert provider panel 422 and a second dispute alert provider panel 424. Each of the first dispute alert provider panel 422 and the second dispute alert provider panel 424 may display data associated with dispute alerts originating from a corresponding dispute alert provider. For example, the first dispute alert provider panel 422 may display transaction descriptors for disputed transactions that correspond to dispute alerts from one dispute alert provider. The second dispute alert provider panel 424 may display transaction descriptors for disputed transaction that correspond to dispute alerts from a different dispute alert provider. The transaction descriptors may include, for example, an identifier assigned by the dispute alert process 140, a case identifier, an order identifier, a received date, a transaction date, an amount, a bank identification number, the last four digits of the corresponding payment card, a card issuer, a merchant identifier, and a descriptor.

In some example embodiments, the graphic user interface 400 may further additional panels for at-a-glance statistics. For example, the graphic user interface 400 may include an overall dispute alert count panel 432 that displays a total number of dispute alerts for a particular merchant (e.g., the merchant 150). The graphic user interface 400 may also include separate panels that show a total number of dispute alerts from each individual dispute alert provider. For example, a first chargeback provider alert count panel 434 may display a total number of dispute alerts originating from one dispute alert provider while a second chargeback provider alert count panel 436 may display a total number of dispute alerts originating from a different dispute alert provider.

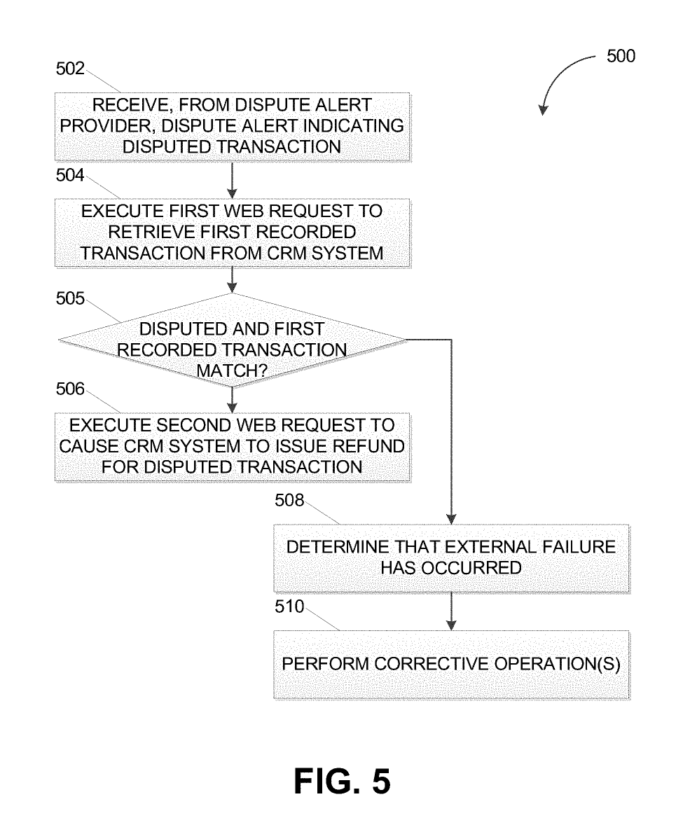

FIG. 5 depicts a flowchart illustrating a process 500 for processing one or more dispute alerts. Referring to FIGS. 1-2 and 5, the process 50 may be performed by the dispute alert processor 140.

The dispute alert processor 140 may receive, from a dispute alert provider, a dispute alert for a disputed transaction (502). For example, the dispute alert processor 140 may receive a dispute alert pushed (e.g., using one or more web service requests) from the dispute alert provider 130 and/or the card issuer 120. The dispute alert may include a plurality of transaction descriptors characterizing various aspects of the disputed transaction including, for example, transaction descriptors that indicate when and where the disputed transaction was executed, the current status of the disputed transaction, and an amount of the disputed transaction.

The dispute alert processor 140 may execute a first web request to retrieve a first recorded transaction from a customer relationship management system (504). For example; the dispute alert processor 140 may execute one or more Hypertext Transfer Protocol requests (e.g., GET) to retrieve one or more recorded transactions from the customer relationship management system 155 of the merchant 150.

The dispute alert processor 140 may determine whether the disputed transaction matches the first recorded transaction (505). In some example embodiments, the dispute alert processor 140 may generate a weighted sum of matching transaction descriptors between the disputed transaction and the first recorded transactions. For example, the disputed transaction and a recorded transaction may share a plurality of matching transaction descriptors including, for example, a same merchant descriptor, card number, transaction date and time, and currency. The dispute alert processor 140 may generate a weighted sum of the matching transaction descriptors.

The dispute alert processor 140 may determine that the disputed transaction matches the first recorded transaction (505-Y). For instance, the disputed transaction may be determined to match a recorded transaction when the weighted sum of the matching transaction descriptors between the two transactions exceeds a threshold. As such, the dispute alert processor 140 may execute a second web request to cause the customer relationship management system to issue a refund for the disputed transaction (506). For example, the dispute alert processor 140 may execute one or more Hypertext Transfer Protocol requests (e.g., PUT) to cause the customer relationship management system 155 to issue a refund (e.g., the user 110).

Alternately, if the dispute alert processor 140 determines that the disputed transaction does not match the first recorded transaction (505-N), the dispute alert processor 140 may determine that an external failure has occurred (506). For instance, the dispute alert processor 140 may determine that a failure has occurred at the customer relationship management system 155 of the merchant 150. Moreover, in response to determining that the disputed transaction does not match the first recorded transaction, the dispute alert processor 140 may further perform one or more corrective operations (508). For example, the dispute alert processor 140 may perform updates to resolve inconsistencies (e.g., formatting) in the transaction descriptors associated with disputed and/or recorded transactions.

One or more aspects or features of the subject matter described herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which may also be referred to as programs, software, software applications, applications, components, or code, include machine instructions for a programmable processor, and may be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. The logic flows depicted herein may include different and/or additional operations than shown without departing from the scope of the present disclosure. Moreover, one or more operations of these logic flows may be omitted and/or repeated without departing from the scope of the present disclosure.

What is claimed is:

1. A system, comprising:
at least one processor;
at least one memory including program code which when executed causes operations comprising:
receiving, from a dispute alert provider, a dispute alert indicating a disputed transaction, wherein the dispute alert includes a first plurality of transaction descriptors characterizing the disputed transaction;
executing, in response to the received dispute alert, a first web service request to retrieve a first recorded transaction from a customer relationship management system, wherein the first recorded transaction is characterized by a second plurality of transaction descriptors;
determining whether the disputed transaction matches the first recorded transaction at least by generating a weighted sum of at least one transaction descriptor from the first plurality of transaction descriptors that matches a transaction descriptor from the second plurality of transaction descriptors; and
executing, when the disputed transaction matches the first recorded transaction, a second web service request to cause the customer relationship management system to issue a refund for the disputed transaction.

2. The system of claim 1, wherein the first plurality of transaction descriptors indicate at least one of a date and time when the disputed transaction was executed, a merchant that processed the disputed transaction, an amount of the disputed transaction, a status of the disputed transaction, a currency of the disputed transaction, and a reason for the disputed transaction.

3. The system of claim 1 further comprising:
receiving, in response to executing the first web service, the first recorded transaction provided by the customer relationship management system.

4. The system of claim 1, wherein the first web service is executed by at least calling a Hypertext Transfer Protocol GET request.

5. The system of claim 1, wherein the determining further comprises:
generating the weighted sum to include a weight assigned to the at least one transaction descriptor from the first plurality of transaction descriptors that matches a transaction descriptor from the second plurality of transaction descriptors; and
determining whether the weighted sum exceeds a threshold.

6. The system of claim 1, wherein the second web service is executed by at least calling a Hypertext Transfer Protocol PUT request.

7. The system of claim 1, further comprising:
receiving, from a merchant associated with the customer relationship management system, one or more recorded transactions;
storing, in a relational database, one or more recorded transactions received from the merchant; and
retrieving, from the relational database, a second recorded transaction, wherein the retrieving includes executing one or more Structured Query Language operations; and
determining whether the disputed transaction matches the second recorded transaction retrieved from the relational database.

8. The system of claim 1, further comprising:
executing, when the disputed transaction is determined to match the first recorded transaction, a third web service request to determine whether the disputed transaction has already been refunded and/or canceled by the customer relationship management system; and
executing, when the disputed transaction is determined to match the first recorded transaction, the second web service request to cause the customer relationship management system to issue the refund when the disputed transaction has not already been refunded and/or canceled by the customer relationship management system.

9. The system of claim 8, wherein the third web service request is executed by at least calling a Hypertext Transfer Protocol GET request.

10. A method, comprising:
receiving, from a dispute alert provider, a dispute alert indicating a disputed transaction, wherein the dispute alert includes a first plurality of transaction descriptors characterizing the disputed transaction;
executing, in response to the received dispute alert, a first web service request to retrieve a first recorded transaction from a customer relationship management system, wherein the first recorded transaction is characterized by a second plurality of transaction descriptors;
determining whether the disputed transaction matches the first recorded transaction at least by generating a weighted sum of at least one transaction descriptor from the first plurality of transaction descriptors that matches a transaction descriptor from the second plurality of transaction descriptors; and
executing, when the disputed transaction matches the first recorded transaction, a second web service request to cause the customer relationship management system to issue a refund for the disputed transaction.

11. The method of claim 10, wherein the first plurality of transaction descriptors indicate at least one of a date and time when the disputed transaction was executed, a merchant that processed the disputed transaction, an amount of the disputed transaction, a status of the disputed transaction, a currency of the disputed transaction, and a reason for the disputed transaction.

12. The method of claim 10, further comprising:
receiving, in response to executing the first web service, the first recorded transaction provided by the customer relationship management system.

13. The method of claim 10, wherein the first web service is executed by at least calling a Hypertext Transfer Protocol GET request.

14. The method of claim 10, further comprising:
generating the weighted sum to include a weight assigned to the at least one transaction descriptor from the first plurality of transaction descriptors that matches a transaction descriptor from the second plurality of transaction descriptors; and
determining whether the weighted sum exceeds a threshold

15. The method of claim 10, wherein the second web service is executed by at least calling a Hypertext Transfer Protocol PUT request.

16. The method of claim 10, further comprising:
receiving, from a merchant associated with the customer relationship management system, one or more recorded transactions;
storing, in a relational database, one or more recorded transactions received from the merchant; and
retrieving, from the relational database, a second recorded transaction, wherein the retrieving includes executing one or more Structured Query Language operations; and
determining whether the disputed transaction matches the second recorded transaction retrieved from the relational database.

17. The method of claim 10, further comprising:
executing, when the disputed transaction is determined to match the first recorded transaction, a third web service request to determine whether the disputed transaction has already been refunded and/or canceled by the customer relationship management system; and
executing, when the disputed transaction is determined to match the first recorded transaction, the second web service request to cause the customer relationship management system to issue the refund when the disputed transaction has not already been refunded and/or canceled by the customer relationship management system.

18. The method of claim 17, wherein the third web service request is executed by at least calling a Hypertext Transfer Protocol GET request.

19. A non-transitory computer-readable storage medium including program code which when executed by at least one processor causes operations comprising:
receiving, from a dispute alert provider, a dispute alert indicating a disputed transaction, wherein the dispute alert includes a first plurality of transaction descriptors characterizing the disputed transaction;
executing, in response to the received dispute alert, a first web service request to retrieve a first recorded transaction from a customer relationship management system, wherein the first recorded transaction is characterized by a second plurality of transaction descriptors;
determining whether the disputed transaction matches the first recorded transaction at least by generating a weighted sum of at least one transaction descriptor from the first plurality of transaction descriptors that matches a transaction descriptor from the second plurality of transaction descriptors; and
executing, when the disputed transaction matches the first recorded transaction, a second web service request to cause the customer relationship management system to issue a refund for the disputed transaction.

20. The computer program product of claim 19, further comprising:
executing, when the disputed transaction is determined to match the first recorded transaction, a third web service request to determine whether the disputed transaction has already been refunded and/or canceled by the customer relationship management system; and
executing, when the disputed transaction is determined to match the first recorded transaction, the second web service request to cause the customer relationship management system to issue the refund when the disputed transaction has not already been refunded and/or canceled by the customer relationship management system.
